(19) United States
(12) Patent Application Publication
(10) Pub. No.: US 2009/0168185 A1
(43) Pub. Date: Jul. 2, 2009

(54) Electrochromic Windshield with Computer Vision Control

(75) Inventor: Bruce A. Augustine, Lake in the Hills, IL (US)

Correspondence Address: MOTOROLA/FETF, 120 SOUTH LASALLE STREET, SUITE 1600, CHICAGO, IL, 60603-3406, US

(73) Assignee: MOTOROLA, INC., Schaumburg, IL (US)

(21) Appl. No.: 11/965,012

(22) Filed: Dec. 27, 2007

(51) Int. Cl. B60J 3/02

(52) U.S. Cl. 359/613

(57) ABSTRACT

A system [200] includes a first camera system [215, 220] to capture first images of a selected person [100] within a vehicle [105] having a windshield [120] with an electrochromic layer [300] comprised of a plurality of electrochromic pixels [305], and to determine a location of the selected person's eyes. A second camera system [205, 210] captures second images of an area in front of the vehicle and detects a glare source. A processing unit [225] is operably coupled to the first and second camera systems and determines (a) a line-of-sight vector between the location of the eyes of the selected person and the location of the glare source; (b) a location of the windshield through which the line-of-sight vector passes; and (c) changes an opacity of at least one of the electrochromic pixels within a designated distance of the location of the windshield through which the line-of-sight vector passes.

### TECHNICAL FIELD

This invention relates generally to a system and method for reducing glare in the eyes of an operator of a movable vehicle.

### BACKGROUND

Automobile drivers and airplane pilots, for example, need to pay close attention to what is in front of them when driving or flying their vehicles and airplanes, respectively. A distraction for even a short amount of time can result in an accident. As an example, sun glare and headlights of oncoming vehicles can be a major annoyance and distraction for automobile drivers, to the point of leading to accidents.

Windshields with tinted regions and visors have been in use in automobiles for decades. The tinted regions, however, provide no reduction of glare for sources near the horizon, such as the rising or setting sun, or oncoming headlights. Instead, the tinted regions are often located near the very top of the windshield and therefore provide little or no reduction for glare when the sun and/or headlights from oncoming vehicles are located in certain positions relative to an automobile driver's field of vision.

Electrochromic materials have been used in rear-view mirrors to dim headlights to the rear of the vehicle. The electrochromic materials used in rear-view mirrors are typically comprised of a single sheet of electrochromic material that changes its opacity in response to the incidence of headlights on a vehicle behind the driver's vehicle. The electrochromic material changes its opacity from being clear to substantially opaque based on a current and/or voltage applied to the electrochromic material disposed on or within the rear view mirror. By changing the opacity, light from bright headlights in a vehicle behind the user's vehicle can be dimmed. A problem with currently used rear view mirrors is that a single sheet of electrochromic material is used and the opacity of the entire rear view mirror is changed when the headlights are detected, thereby darkening everything visible in the mirror, including objects located away from the headlights. This can reduce the effectiveness of the rear view mirror and increase the chance that the user might not notice an object approaching from behind that is located away from the source of headlights, such as a motorcyclist riding a motorcycle without headlights on.

Electrochromic windows have been used in building construction and vehicle sunroofs to reduce solar heating. A drawback of such windows, however, is that the entire surface of such windows is darkened to the same intensity.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates a driver of an automobile according to the prior art;

FIG. 2 illustrates a top view of an electrochromic glare reduction system according to at least one embodiment of the invention;

FIG. 3 illustrates an enlarged view of a portion of an electrochromic layer of the electrochromic glare reduction system according to at least one embodiment of the invention; and

FIG. 4 illustrates a method for detecting the line-of-sight vector between a glare source and a driver's eyes according to at least one embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments of the present invention. Also, common and well-understood elements that are useful or necessary in a commercially feasible embodiment are often not depicted in order to facilitate a less obstructed view of these various embodiments of the present invention.

### DETAILED DESCRIPTION

Generally speaking, pursuant to these various embodiments, a method, system, and apparatus are provided for an electrochromic windshield having computer vision control. The electrochromic windshield is utilized to reduce glare that can be distracting to a driver or an automobile, a pilot of an airplane, or an operator of any other type of machinery that requires the operator to closely monitor the physical space in front of him or her.

The electrochromic windshield includes an array of electrochromic pixels. A processor or other computer device can selectively change the opacity of a select electrochromic pixel. The opacity can be changed from a state where the electrochromic pixel is clear, i.e., substantially all incident light passes through the electrochromic pixel, to a state where the electrochromic pixel is completely opaque, i.e., substantially no incident light passes through the electrochromic pixel. There are many different levels of opacity that may be achieved with and for each electrochromic pixel. In the event that the windshield is used in an automobile, several cameras are mounted in the automobile. Two or more cameras are mounted facing toward the driver, and two or more cameras are mounted facing away from the driver, i.e., in a direction forward through the windshield, the same direction in which the driver would be looking while driving the automobile.

The cameras may generate a digital video signal that is provided to one or more microprocessors. At least one of the microprocessors is utilized to detect the position of the eyes of the driver of the automobile. The microprocessors may implement facial analysis and recognition algorithms to determine the location of certain aspects of the driver's body. In some examples, the exact location of the driver's eyes or the pupils of the drivers' eyes is determined. In other examples, the location of the driver's head is determined and the location of the driver's eyes is estimated based on known facial characteristics. For example, if the location of a driver's forehead or eyebrows can be determined, the location of the driver's eyes can be estimated based on the knowledge that the eyes are below the forehead and are generally within a certain distance range from the forehead and/or eyebrows of the driver.

After the general location of the driver's eyes is determined, the microprocessors determine a line-of-sight vector between the driver's eyes and a source of glare. The source of glare may be direct sunlight or oncoming headlights. In the event that the source of glare is direct sunlight or oncoming headlights, it is generally presumed that the source of glare will be in front of the driver. In other embodiments, additional sources of glare, such as reflections of sunlight off of windows of other automobiles or off of the hood of the driver's automobile may also be detected.

Once the line-of-sight vector has been determined, the location at which the vector passes through the windshield of the driver's automobile is subsequently determined. The windshield includes an electrochromic material formed of electrochromic pixels. The electrochromic pixels may have the shape of a hexagon and may be about one millimeter between opposite sides. It should be appreciated that other sized electrochromic pixels may also be used, as well as shapes other than hexagons. For example, the electrochromic pixels may be circular, rectangular, or square depending on the application.

The electrochromic pixels in the area of the windshield through which the vector passes are subsequently darkened, i.e., their opacity is changed, to minimize the glare directed toward the driver's eyes. The electrochromic pixels change polarity in response to application of a voltage and/or current. In some embodiments, there may be a plurality of different states that the electrochromic pixels can embody, based on the voltage. For example, when no voltage is applied to an electrochromic pixel, the electrochromic pixel may be lucid, i.e., clear. In the event that the electrochromic pixel has an operating range between 0 and 5 Volts, the application of 5 Volts may change the polarity of the electrochromic pixel so that no light passes through. In other words, the electrochromic pixel would be completely opaque or black. The application of a different voltage between 0 and 5 volts would change the polarity of the electrochromic pixel such that some light passes through the electrochromic pixel, but no as much as would pass through if 0 volts were applied. The greater the voltage that is applied, the less light will pass through the electrochromic pixel and the darker the electrochromic pixel will appear to be. In other embodiments, the voltage works in reverse whereby more light passes through the electrochromic pixel in response to an increasing voltage such that the electrochromic pixel is lucid or clear at 5 Volts and no light passes through the electrochromic pixel when 0 Volts are applied.

The electrochromic pixels closest to the driver's line-of-sight vector may be darkened the most, whereas other nearby electrochromic pixels may be darkened a lesser amount. The line-of-sight vector between the driver's eyes and the glare source may be continually computed such as, for example, every second or every 15 seconds, depending on the particular application and the processor power available.

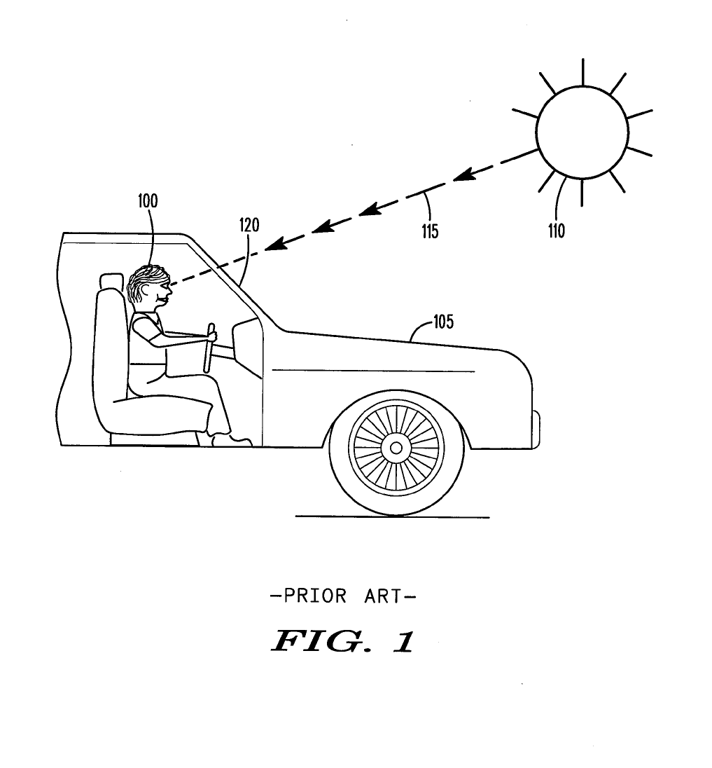

FIG. 1 illustrates a driver 100 of an automobile 105 according to the prior art. As shown, the sun 110 is shining and emitting a bright ray 115 of light that is shining through a windshield 120 into the driver's 100 eyes. The bright ray 115 or glare from the sun 110 is distracting to the driver 100. In some instances, the automobile 105 may have a sun visor to block out light entering near the top of the windshield 120. However, the rays 115 from the sun 110 or glare from oncoming headlights often passes through the windshield 120 at a location below the sun visor, causing distraction. This can be especially problematic when the driver 100 is driving the automobile 105 when the sun is setting and is low on the horizon.

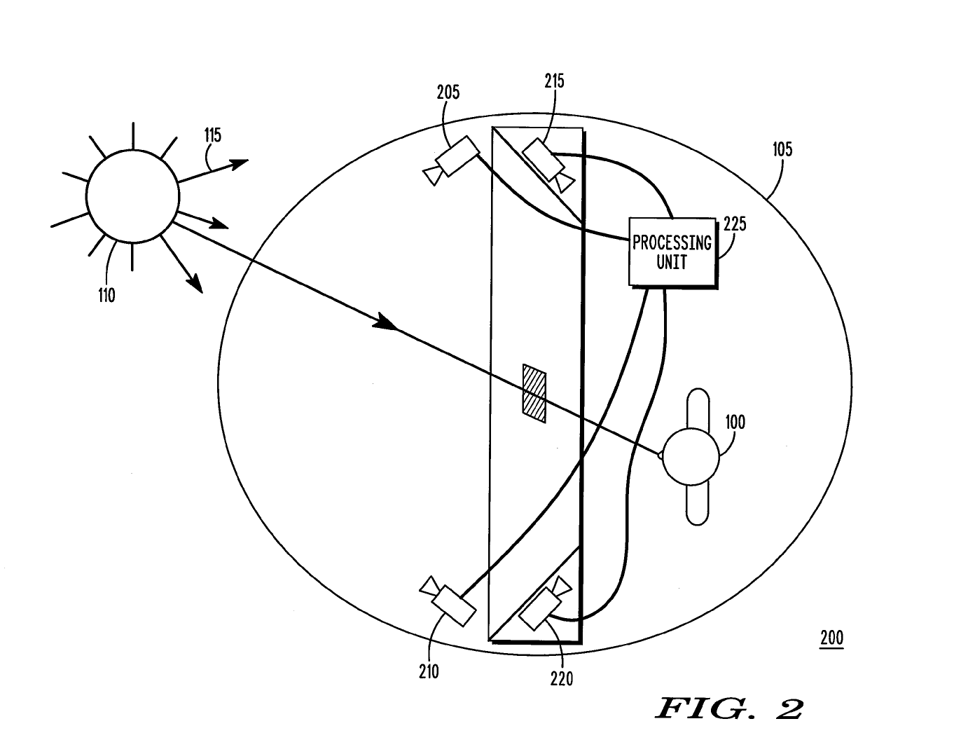

FIG. 2 illustrates a top view of an electrochromic glare reduction system 200 according to at least one embodiment of the invention. As shown, a driver 100 is inside of an automobile 105. The sun 110 is in front of the driver's 100 field of vision and emits various sunrays 115. Some of the sunrays 115 are directed toward the windshield 120 of the automobile 105 and pass through the windshield 120 and into the interior of the automobile 105. The electrochromic glare reduction system 200 includes several cameras for acquiring images utilized to detect a source of glare and for determining a location of the driver's 100 eyes. A first camera 205 is located on or near the right-hand side of the windshield 120 and faces forward, i.e., away from interior of the automobile 105. A second camera 210 is located on or near the left-hand side of the windshield 120 and also faces forward. A third camera 215 is located on or near the right-hand side of the windshield 120 and faces toward the interior of the automobile 105. A fourth camera 220 is located on or near the left-hand side of the windshield 120 and also faces toward the interior of the automobile 220. The third camera 215 and the fourth camera 220 may be pointed in the direction of where the driver 100 would typically sit.

The first camera 205, second camera 210, third camera 215, and fourth camera 220 may each provide digital outputs of the video imagery they capture and provide such outputs to a processing unit 225. The outputs from the first camera 205 and the second camera 210 are utilized to determine a source of glare. In this example, the source of glare is the sun 110, which generates solar rays 115. The outputs from the third camera 215 and the fourth camera 220 are utilized to determine the location of the driver's 100 eyes. By analyzing the images from the third camera 215 and the fourth camera 220, the processing unit can determine the location of the driver's head or face. Once the location of the head or face is known, the location of the driver's 100 eyes may be estimated based on known facial feature characteristics. For example, if the top of the driver's 100 head is detected, it may be determined that the driver's eyes are a few inches below the top of the head. This process can be used to estimate the location of the driver's 100 eyes even in the event that the driver is wearing glasses. A distance range from the top of the driver's 100 head is utilized to account for situations in which the driver 100 has hair extending upwardly from the head or is wearing a hat.

In other embodiments, the driver's 100 eyebrows are detected and the eyes are estimated to be within a certain distance below the eyebrows. In additional embodiments, the driver's 100 eyes are directly detected. By yet another approach, glasses (such as sunglasses or ordinary vision-correction glasses) as are ordinarily worn by the driver can be configured with a unique marker that is readily identifiable by this system and which can be used as a registration marker to thereby determine the location of the driver's eyes.

The outputs from the first camera 205 and the second camera 210 are utilized to determine the location of a source of glare. The first camera 205 and the second camera 210 may each include a complimentary metal oxide semiconductor (CMOS) sensor. In the event that a source of glare is present, as is the case in this example, the light from the glare source will saturate the portion of the CMOS sensor corresponding to the glare source. In this case, the portion of an image from the first camera 205 in which the sun 110 is located would be saturated with light. By using two cameras facing in each direction, i.e., the first camera 205 and the second camera 210 facing outward in front of the automobile, and the third camera 210 and the fourth camera 220 facing inward toward the interior of the automobile 105, 3-dimensional imagery may be captured and analyzed by combining the images of the two cameras facing in each respective direction. In some embodiments, more than two cameras may be utilized to capture images in each direction.

After the location of one or more glare sources is determined and the location of the driver's eyes has been estimated, the processing unit 225 determines a line-of-sight vector, i.e., a vector between the glare source and the driver's 100 eyes. The location at which the vector passes through the windshield 120 is estimated and the electrochromic pixels around the location where the vector passes through the windshield are polarized, i.e., darkened to block out some of the light from the glare source, so as to avoid distraction to the driver 100. Electrochromic pixels near the location at which the vector is calculated to pass through the windshield 120 may also be darkened to account for the tolerances due to the fact that the locations of the driver's 100 eyes are estimated. In some embodiments, the electrochromic pixels directly at the location at which the vector is calculated to pass through the windshield 120 are polarized more than are the surrounding electrochromic pixels. The electrochromic pixels are polarized via the application of a voltage and/or current. The processing unit 225 may control the application of the voltage and a battery and/or alternator in the engine compartment of the automobile 105 may supply the voltage. In alternative embodiments, a separate battery may be utilized to provide power to the electrochromic pixels.

It should be appreciated that although the first camera 205, the second camera 210, the third camera 215, and the fourth camera 220 are illustrated as being located near the far opposite ends of the windshield 120, the cameras could be placed in other locations in other embodiments. In some embodiments, one or more of the cameras may be mounted on the windshield 120. In other embodiments, one or more of the cameras may be mounted in other locations of the automobile 105, such as on the dashboard, on the doors, on the rear-view mirror, on the ceiling of the interior of the automobile 105, or in any other location suitable for capturing the relevant images without distracting the driver 100. In some embodiments, the first camera 205 and the second camera 210 may be located within the upright support beams of the automobile 105 or next to the headlights.

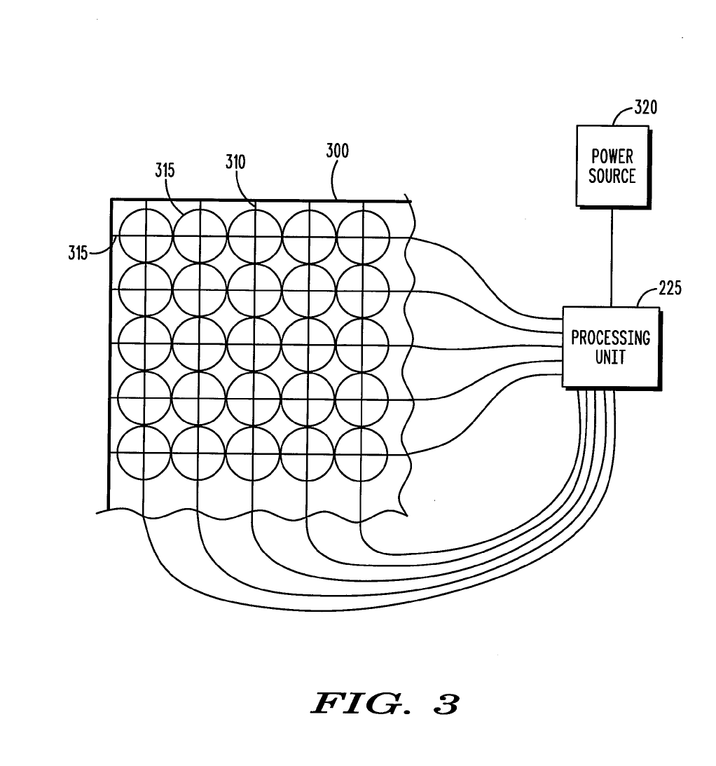

FIG. 3 illustrates an enlarged view of a portion of an electrochromic layer 300 of the electrochromic glare reduction system 200 according to at least one embodiment of the invention. In some embodiments, the windshield 120 may be formed of two separate layers of glass or another lucid material. In such embodiments, the electrochromic layer 300 may be sandwiched in between the two layers, such that the electrochromic layer 300 resides within the windshield 120. In other embodiments, the electrochromic layer 300 may be located on one side of the windshield 120, such as the side facing the interior of the automobile 105.

The electrochromic layer 300 includes a plurality of adjacent electrochromic pixels 305. As discussed above, the polarity of each of the electrochromic pixels may be set or changed via the application of a voltage or current to the electrochromic pixel. Electrical connections exist between the processing unit 225 or another controller and each of the electrochromic pixels. The electrical connections may comprise wires or some other conductive material. The wires may be clear/lucid so that the driver 100 can see through them when they are at least partially located on the windshield 120.

The wires may be arranged in a grid-like fashion such that two wires are electrically coupled to each of the electrochromic pixels. As illustrated, vertical control wires 310 pass through each vertically adjacent electrochromic pixel, and horizontal control wires 315 pass though each horizontally adjacent electrochromic pixel. In the event that only certain electrochromic pixels are to be polarized, an electrochromic pixel to be polarized may be selected by applying a voltage to both the vertical control wire 310 and the horizontal control wire 315 passing through the select electrochromic pixel. Although a control voltage passes through each of the electrochromic pixels in the same vertical column and horizontal row, the electrochromic pixel may be adapted to only become polarized in the event that control voltages are received from both a vertical control wire 310 and a horizontal control wire 315 at the same time.

In some embodiments, upon being enabled, a selected electrochromic pixel is polarized via one of the control voltages received. In other embodiments, a separate voltage control wire is included to include the level of polarization. The electrical power is provided by a power source 320. The power source 320 may be the automobile's engine battery. Alternatively, the power source may be a separate battery or a solar panel.

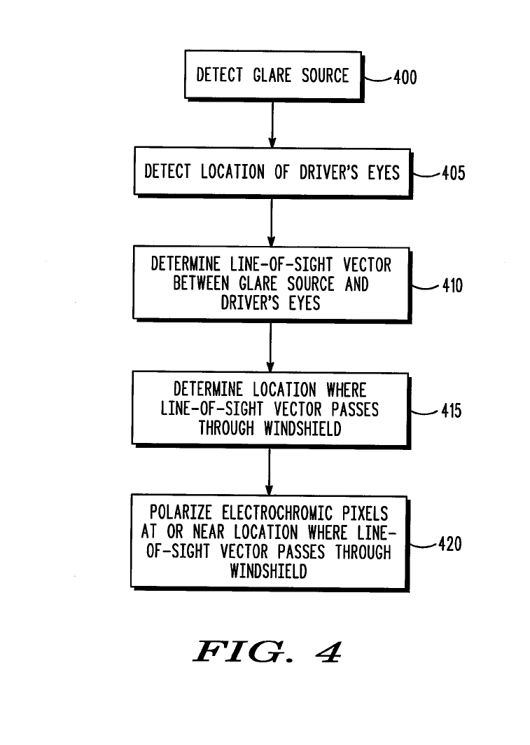

FIG. 4 illustrates a method for detecting the line-of-sight vector between a glare source and a driver's eyes according to at least one embodiment of the invention. First, at operation 400, a glare source is detected. As discussed above, the glare source may be the sun, oncoming headlights, or any other source of bright light. Next, at operation 405, the locations of the driver's eyes are detected. The line-of-sight vector between the glare source and the driver's eyes is determined at operation 410 and the location at which the line-of-sight vector passes though the windshield 120 is determined at operation 415. Finally, at operation 420, the electrochromic pixels at or near the location at which the line-of-sight vector passes through the windshield are polarized at operation 420.

The method illustrated in FIG. 4 may be repeated periodically. For example, the method may be repeated every 5 seconds to determine a new line of-sight-vector. Periodically computing the line-of-sight vector can help to provide improved glare reduction. In the event that the driver is driving on a curved road or driving up an incline or down a decline, the line-of-sight vector may quickly alter its direction. Accordingly, by quickly calculating a new line-of-sight vector, different electrochromic pixels may be polarized to minimize the annoyance to the driver caused by glare.

In some embodiments, the driver can manually enable or disable the electrochromic windshield from operation by performing a designated action such as pressing a user-assertable switch or a specified button on the dashboard or entering a code. In the event that the driver disables the electrochromic windshield all of the pixels may change their polarization to the lowest possible level such that they are clear or lucid. This may be desirable when driving at night on sparsely traveled roads where the chances of driving past another automobile with annoying bright headlights are minimal.

The electrochromic windshield may be used as a visor when the automobile is not in use. For example, the driver may perform a designated action such as pressing a specified user-assertable switch or button to cause all of the pixels in the electrochromic windshield (or only in some specific portion of the windshield) to become polarized at the same time. This may be useful when the automobile in a climate that can become very warm. In such embodiments, the pixels may become polarized at the initial time that a voltage is applied and may keep this polarization until a new voltage is applied.

Although the embodiments above have been described with respect to an automobile, it should be appreciated that the teachings are equally applicable to other embodiments. For example, an electrochromic windshield could also be utilized in an aircraft, such as an airplane or helicopter to reduce glare. Moreover, although the teaching have been described only with respect to a driver of an automobile, the teachings are equally applicable to other passengers in the automobile to reduce the annoyance of glare to those passengers

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A system, comprising:
a first camera system to capture first images of a selected person within a vehicle having a windshield with an electrochromic layer comprised of a plurality of electrochromic pixels, and to determine a location of the selected person's eyes;
a second camera system to capture second images of an area in front of the vehicle and to detect a glare source;
a processing unit operably coupled to the first camera system and the second camera system to
determine a line-of-sight vector between the location of the eyes of the selected person and the location of the glare source;
determine a location of the windshield through which the line-of-sight vector passes;
change an opacity of at least one of the electrochromic pixels within a designated distance of the location of the windshield through which the line-of-sight vector passes.

2. The system of claim 1, wherein the processing unit is adapted to change the opacity of the at least one of the electrochromic pixels by providing a control signal to the at least one of the electrochromic pixels.

3. The system of claim 1, wherein the vehicle is an automobile.

4. The system of claim 1, wherein the vehicle is an airplane.

5. The system of claim 1, wherein the electrochromic layer is disposed within the windshield.

6. The system of claim 1, further comprising a user-assertable switch to enable the electrochromic pixels.

7. The system of claim 1, further comprising a user-assertable switch to polarize the electrochromic pixels.

8. A system, comprising:
a vehicle having a windshield with an electrochromic layer comprised of a plurality of electrochromic pixels;
a first camera system to capture first images of a selected person within the vehicle and to determine a location of the selected person's eyes;
a second camera system to capture second images of an area in front of the vehicle and to detect a glare source;
a processing unit operably coupled to the first camera system and the second camera system to
determine a line-of-sight vector between the location of the eyes of the selected person and the location of the glare source;
determine a location of the windshield through which the line-of-sight vector passes;
change an opacity of at least one of the electrochromic pixels within a designated distance of the location of the windshield through which the line-of-sight vector passes.

9. The system of claim 8, wherein the vehicle is an automobile.

10. The system of claim 8, wherein the vehicle is an airplane.

11. The system of claim 8, wherein the electrochromic layer is disposed within the windshield.

12. The system of claim 8, further comprising a user-assertable switch to enable the electrochromic pixels.

13. The system of claim 8, further comprising a user-assertable switch to polarize all of the electrochromic pixels.

14. A method, comprising:
detecting a location of a selected person's eyes in a vehicle having a windshield with an electrochromic layer comprised of a plurality of electrochromic pixels;
detecting a location of a glare source;
determining a line-of-sight vector between the location of the eyes of the selected person and the location of the glare source;
determining a location of the windshield through which the line-of-sight vector passes;
changing an opacity of at least one of the electrochromic pixels within a designated distance of the location of the windshield through which the line-of-sight vector passes.

15. The method of claim 14, wherein the selected person is a driver of the vehicle.

16. The method of claim 14, wherein the vehicle is an automobile.

17. The method of claim 14, wherein the vehicle is an airplane.

18. The method of claim 14, the detecting the location of the eyes of the selected person being performed based on an analysis of images provided by at least two cameras within the vehicle.

19. The method of claim 14, the detecting the location of the glare source being performed based on an analysis of images provided by at least two cameras facing in a direction toward an exterior of the vehicle.
